(19) United States
(12) Patent Application Publication
(10) Pub. No.: US 2013/0100371 A1
(43) Pub. Date: Apr. 25, 2013

(54) Liquid Crystal Display Device

(71) Applicant: Gang Yu, Shenzhen (CN)

(72) Inventor: Gang Yu, Shenzhen (CN)

(21) Appl. No.: 13/378,496

(22) PCT Filed: Oct. 28, 2011
(86) PCT No.: PCT/CN11/81474

§ 371 Date: Dec. 15, 2011

(30) Foreign Application Priority Data
Oct. 20, 2011 (CN) 20110320409.8

(51) Int. Cl. G02F 1/1333

(52) U.S. Cl. 349/58

(57) ABSTRACT

The present invention discloses a liquid crystal display (LCD) device. A LCD device comprises a LCD panel and a frame for fixing the LCD panel, wherein the matching holes and protruding modules are respectively arranged on the contact surfaces of the frame and the LCD panel; and the frame and the LCD panel are fixed by a way of embedding the protruding modules in the holes. The present invention can keep the LCD panel in place to prevent the LCD panel from moving laterally under the conditions of vibration etc. by providing the protruding modules and the holes for the contact surfaces of the LCD panel and the frame, and using the lateral limitation by embedding the protruding modules in the holes. Therefore, even as in the presence of narrow frame, the LCD panel is prevented from damages due to disconnection from the front frame. Thus, the positioning capability of the LCD panel is greatly improved.

### TECHNICAL FIELD

The present invention relates to the field of liquid crystal displays (LCDs), and more particularly to a LCD device.

### BACKGROUND

With the narrowing of a frame of a liquid crystal television, a LCD panel module will be correspondingly designed as a narrow frame structure. The structure of the existing LCD panel module is as shown in FIG. 1, and a LCD panel 900 of a LCD panel module is limited and fixed by a front frame 100. As the narrow frame is being designed, the coincident distance h of the LCD panel 900 and the front frame 100 becomes smaller, the reliability of the positioning of the LCD panel 900 is being greatly reduced, resulting in the proning to disconnection of a LCD panel during carrying and vibration, etc.

### SUMMARY

One aim of the present invention is to provide a LCD device which can improve the positioning capability of the LCD panel by using the narrow frame design.

The purpose of the present invention is achieved by the following technical schemes:

A LCD device comprises a LCD panel and a frame for fixing the LCD panel, wherein the matching holes and protruding modules are respectively arranged on the contact surfaces of the frame and the LCD panel, and the frame and the LCD panel are fixed by a way of embedding the protruding modules in the holes.

Preferably, the frame comprises a front frame which is in contact with the light emergent surface of the LCD panel; the protruding modules are arranged on the contact surface of the front frame; and correspondingly, the holes are arranged on the contact surface of the LCD panel. This is a specific cooperation mode of the protruding modules and the holes.

Preferably, the frame also comprises a middle frame, wherein the support surface of the middle frame is in contact with the light incident surface of the LCD panel; the holes are located at the area opposite to the support surface. In the embodiment, the holes are blocked by the support surface to avoid light leakage.

Preferably, the holes are through holes; the bayonet is located at the area where the support surface is opposite to the through holes, and the protruding modules are embedded in the bayonet after passing through the through holes. The support surface is provided with a bayonet while the protruding modules are embedded in the bayonet. Thus, the bases of the protruding modules are located on the front frame, and the ends are butted with the bayonet; thereof the protruding modules can withstand the greater impact intensity of vibration to further improve the positioning capability of the LCD panel.

Preferably, folded edges are arranged on an end of the front frame which is in contact with the LCD panel to form the protruding modules, and the frame and the LCD panel is fixed by a way of embedding the folded edges in the holes. This is a specific mode of the protruding modules, with the folded edges at the edge of the front frame; the processing is convenient and additional materials are not required.

Preferably, the frame comprises a middle frame, wherein the support surface of the middle frame is in contact with the light emergent surface of the LCD panel; the protruding modules are arranged on the contact surface of the middle frame; and correspondingly, the holes are arranged on the contact surface of the LCD panel. This is a cooperation mode between the middle frame and the LCD panel by using the protruding modules and the holes.

Preferably, the frame comprises a front frame which is in contact with the light emergent surface of the LCD panel; the holes are through holes, the bayonet is located at the area where the front frame is opposite to the through holes, and the protruding modules are embedded in the bayonet after passing through the through holes. The front frame is provided with the bayonet while the protruding modules are embedded in the bayonet. Thus, the bases of the protruding modules are located on the support surface of the middle frame, and the ends are butted with the bayonet; thereof the protruding modules can withstand the greater impact intensity of vibration to further improve the positioning capability of the LCD panel.

Preferably, the frame comprises a front frame which is in contact with the light emergent surface of the LCD panel; the holes are arranged on the contact surface of the front frame; and correspondingly, the protruding modules are arranged on the contact surface of the LCD panel. This is a technical scheme that the protruding modules are arranged on the LCD panel and the holes are arranged on the front frame.

Preferably, the frame comprises a middle frame which is in contact with the light incident surface of the LCD panel; the holes are arranged on the contact surface of the middle frame; and correspondingly, the protruding modules are arranged on the contact surface of the LCD panel. This is a technical scheme that the protruding modules are arranged on the LCD panel and the holes are arranged on the middle frame.

By providing the protruding modules and the holes for the contact surfaces of the LCD panel and the frame, and using the lateral limitation by embedding the protruding modules in the holes, the present invention can keep the LCD panel in place to prevent the LCD panel from moving laterally under the conditions of vibration. Therefore, even in the presence of narrow frame, the LCD panel is prevented from damages due to disconnection from the front frame. Thus, the positioning capability of the LCD panel is greatly improved, and the possibility that the frame is further narrowed is provided.

### BRIEF DESCRIPTION OF FIGURES

FIG. 1 is a structural diagram of the existing LCD device;

FIG. 2 is a structural diagram of the embodiment of the present invention;

FIG. 3 is a structural diagram of embodiment 1 of the present invention;

FIG. 4 is a structural diagram of embodiment 2 of the present invention;

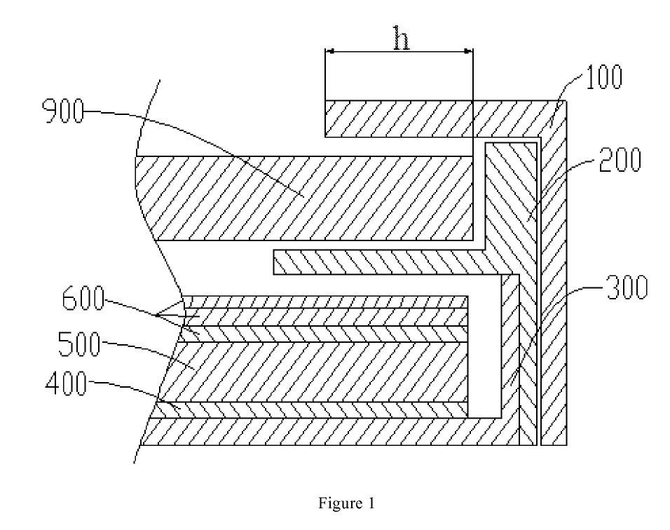

Wherein: 100. Front frame; 110. Folded edge; 200. Middle frame; 210. Bayonet; 300. Backplane; 400. Reflection sheet; 500. Light guide plate; 600. Optical diaphragm; 900. LCD panel; 910. Hole.

### DETAILED DESCRIPTION

The present invention will further be described in detail in accordance with the figures and the preferred embodiments.

A LCD device comprises a bottom backplane 300 which sequentially comprises a reflection sheet 400, a light guide plate 500, an optical diaphragm 600, and a LCD panel 900; wherein the LCD panel 900 is fixed by the frame; wherein, the frame comprises the outermost front frame 100 and the innermost middle frame 200; for the front frame 100, the light emergent surface of the LCD panel 900 is provided with a flange to block out the edges of the LCD panel 900, and the coincident distance between the front frame 100 and the LCD panel 900 is h; for the middle frame 200, the light incident surface of the LCD panel 900 is provided with a support surface, and the LCD panel 900 is fixed by the clamping of the flange and the support surface. The contact surfaces of the frame and the LCD panel 900 are respectively provided with the matching holes 910 and protruding modules, wherein, the frame and the LCD panel 900 is fixed by a way of embedding the protruding modules in the holes 910. The holes 910 are arranged on the LCD panel 900 and the protruding modules are arranged on the frame, and this is used as an example to explain:

### Embodiment 1

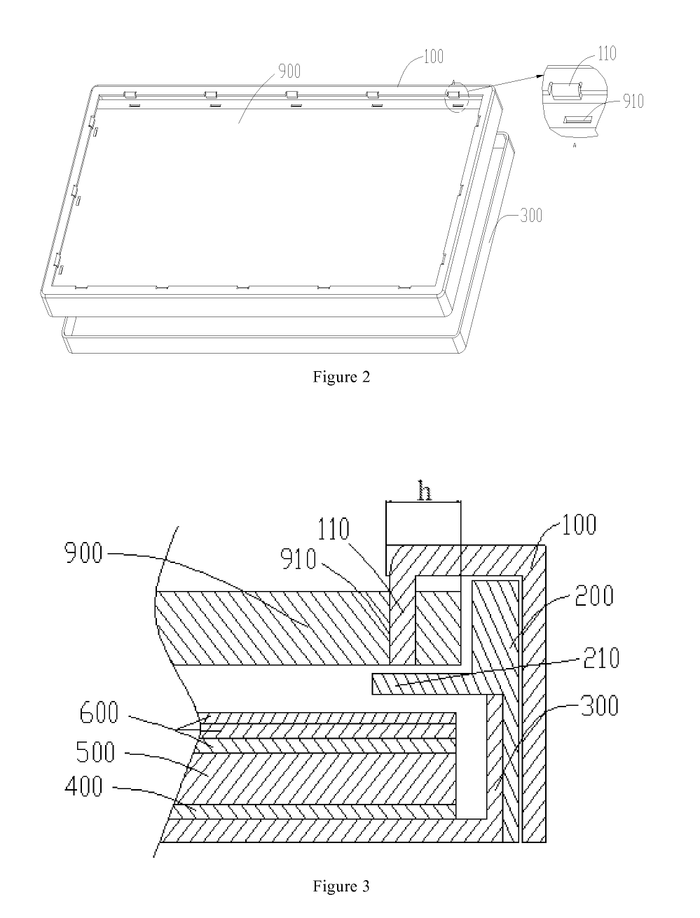

As shown in FIG. 2 and FIG. 3, the frame comprises a front frame 100 and a middle frame 200 of the LCD device; wherein, the folded edges 110 are arranged on an end of the front frame 100 which is in contact with the LCD panel 900 to form the protruding modules, and the front frame 100 and the LCD panel 900 are fixed by a way of embedding the folded edges 110 in the holes 910.

The support surface of the middle frame 200 is in contact with the light incident surface of the LCD panel 900; the holes 910 are located at the area opposite to the support surface, and the holes 910 can be through holes as well as blind holes.

During installation, the front frame 100 is clamped in the holes 910 to keep the LCD panel 900 in place, preventing a reduction of reliability problem, such as a disconnection due to vibration, because the coincident distance h of the LCD panel 900 and the front frame 100 is undersized. The holes 910 can be located on the support surface of the middle frame 200 so that to preclude the phenomenon of light leakage due to the bayonet 210.

### Embodiment 2

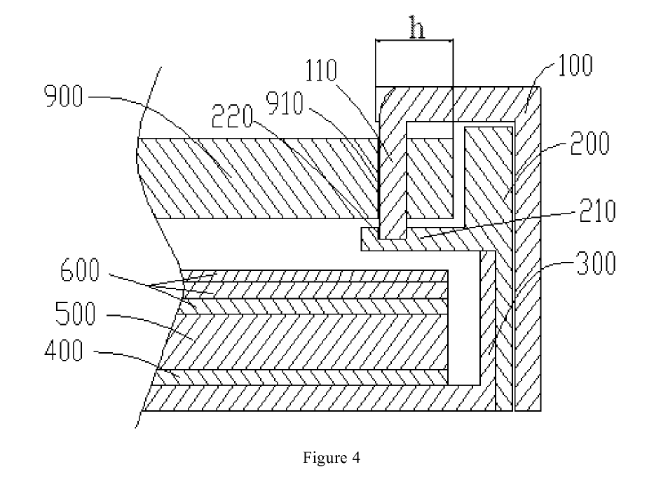

As shown in FIG. 2 and FIG. 4, the frame comprises a front frame 100 and a middle frame 200 of the LCD device; wherein, the folded edges 110 are arranged on an end of the front frame 100 which is in contact with the LCD panel 900 to form the protruding modules, and the front frame 100 and the LCD panel 900 are fixed by a way of embedding the folded edges 110 in the holes 910.

The support surface of the middle frame 200 is in contact with the light incident surface of the LCD panel 900; the holes 910 are located at the area opposite to the support surface; the holes 910 are through holes; the bayonet 210 is arranged on the location where the support surface is opposite to the through holes; and the folded edges 110 are embedded in the bayonet 210 after passing through the through holes.

During installation, the front frame 100 is clamped in the holes 910 to fix the LCD panel 900, preventing a reduction of reliability problem, such as a disconnection due to vibration, because the coincident distance h of the LCD panel 900 and the front frame 100 is undersized. The holes 910 can be located on the support surface of the middle frame 200 so that to preclude the phenomenon of light leakage due to the bayonet 210; the support surface of the middle frame 200 is provided with the corresponding bayonet 210 which can be a blind hole as well as a through hole, thus the positioning effect can be improved.

### Embodiment 3

The frame comprises a front frame 100 and a middle frame 200 of the LCD device, wherein the support surface of the middle frame 200 is in contact with the light incident surface of the LCD panel 900; and the protruding modules are arranged on the contact surface; correspondingly, the holes 910 are arranged on the contact surface of the LCD panel 900, and the middle frame 200 and the LCD panel 900 are fixed by a way of embedding the folded edges 110 in the holes 910. The holes 910 can be through holes as well as blind holes.

### Embodiment 4

The frame comprises a front frame 100 and a middle frame 200 of the LCD device, wherein the support surface of the middle frame 200 is in contact with the light incident surface of the LCD panel 900; and the protruding modules are arranged on the contact surface; correspondingly, the holes 910 are arranged on the contact surface of the LCD panel 900, and the middle frame 200 and the LCD panel 900 are fixed by a way of embedding the folded edges 110 in the holes 910. The front frame 100 is in contact with the light emergent surface of the LCD panel 900; the holes 910 are through holes; the bayonet 210 is located on the position where the front frame 100 is opposite to the through holes; and the protruding modules are embedded in the bayonet 210 of the front frame 100 after passing through the through holes.

The present invention is described in detail in accordance with the above contents with the specific preferred embodiments. However, this invention is not limited to the specific embodiments. The protection range of the present invention should be considered to to include any additional one or more embodiments that the LCD panel 900 is provided with the protruding modules and the frame is provided with the holes 910; for example, the protruding modules of the LCD panel 900 will match the holes 910 of the front frame 100, or the protruding modules of the LCD panel 900 will match the holes 910 of the middle frame 200, etc.

We claim:

1. A liquid crystal display (LCD) device, comprising: a LCD panel and a frame for fixing the LCD panel; the contact surfaces of the frame and the LCD panel are respectively provided with the matching holes and protruding modules; and the frame and the LCD panel are fixed by a way of embedding the protruding modules in the holes.

2. A LCD device of claim 1, wherein the frame comprises a front frame which is in contact with the light emergent surface of the LCD panel; and the protruding modules are arranged on the contact surface of the front frame; correspondingly, the holes are arranged on the contact surface of the LCD panel.

3. A LCD device of claim 2, wherein the frame also comprises a middle frame, and the support surface of the middle frame is in contact with the light incident surface of the LCD panel; the holes are located at the area opposite to the support surface.

4. A LCD device of claim 3, wherein the holes are through holes; the bayonet is located on the position of the support surface opposite to the through holes; and the protruding modules are embedded in the bayonet after passing through the through holes.

5. A LCD device of claim 2, wherein the folded edges are arranged on an end of the front frame which is in contact with the LCD panel to form the protruding modules, and the frame and the LCD panel are fixed by the way of embedding the folded edges into the holes.

6. A LCD device of claim 1, wherein the frame comprises a middle frame, and the support surface of the middle frame is in contacts with the light incident surface of the LCD panel; the contact surface of the middle frame is provided with the protruding modules; correspondingly, the contact surface of the LCD panel is provided with the holes.

7. A LCD device of claim 6, wherein the frame comprises a front frame which is in contact with the light emergent surface of the LCD panel; the holes are through holes; the bayonet is located on the position of the frame opposite to the through holes, and the protruding modules are embedded in the bayonet after passing through the through holes.

8. A LCD device of claim 1, wherein the frame comprises a front frame which is in contact with the light emergent surface of the LCD panel; and the contact surface of the front frame is provided with the holes; correspondingly, the contact surface of the LCD panel is provided with the protruding modules.

9. A LCD device of claim 1, wherein the frame comprises a middle frame; the support surface of the middle frame is in contact with the light incident surface of the LCD panel; and the contact surface of the middle frame is provided with the holes; correspondingly, the contact surface of the LCD panel is provided with the protruding modules.
